(19) United States
(12) Patent Application Publication
(10) Pub. No.: US 2009/0016197 A1
(43) Pub. Date: Jan. 15, 2009

(54) OPTICAL PICKUP AND OPTICAL DISK DEVICE

(75) Inventor: Satoshi Shimokawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/167,619

(22) Filed: Jul. 3, 2008

(30) Foreign Application Priority Data
Jul. 10, 2007 (JP) 2007-180673

(51) Int. Cl. G11B 7/00

(52) U.S. Cl. 369/112.23

(57) ABSTRACT

An optical pickup includes: a plurality of object lenses mounted in a central portion; a lens holder having tracking and focusing coils distributed between two side portions; a fixed base having a plurality of magnets paired with the tracking and focusing coils and a plurality of stand-up mirrors each facing a different one of the object lenses; a plurality of wires supporting the two side portions of the lens holder; a coil substrate having a winding pattern as a tracking coil and integrated with the lens holder so as to cross through the central portion of the lens holder and project beyond the two side portions while avoiding the object lenses and the stand-up mirrors. A plurality of through holes are formed in the coil substrate for electrically connecting the plurality of wires as leads to the tracking and focusing coils.

### CROSS-REFERENCE TO RELATED APPLICATIONS

This application is based upon and claims the benefit of priority of the prior Japanese Application No. 2007-180673, filed on Jul. 10, 2007, the entire contents of which are incorporated herein by reference.

### BACKGROUND

1. Field

This invention is related to an optical pickup for recording to and readout from an optical disk, and to an optical disk device equipped with the optical pickup.

2. Description of the Related Art

An example of an optical pickup of the prior art is disclosed in Japanese Patent Publication Laid-Open No. 2006-309911. This optical pickup includes a lens holder (movable body) provided with two object lenses mounted in a central portion, tracking and focusing coils provided in each of two side portions, and a plurality of magnets paired with the tracking and focusing coils. The optical pickup includes a fixed base provided with a plurality of stand-up mirrors which oppose the object lenses with a one-to-one correspondence and a plurality of wires giving cantilever-type support to the two side portions of the lens holder. In addition to supporting the lens holder in a way which allows vertical, leftward, and rightward movement, these wires functions as leads for supplying electric power to the coils. The tracking and focusing coils are integrated into the lens holder. The coils and wires are connected with a wiring operation, and the left and right coils are connected via a harness or the like.

The conventional optical pickups of the type previously described in have a shortcoming in that it is difficult to implement the wiring because the connections between the coils and the wires and between the coils themselves are complicated and because the parts are small and intricate.

The present invention was conceived with a view to solving the above-described problem. The present invention has one object of providing an optical pickup with simple connections between the coils and the wires to simplify implementation of the wiring, and an optical disk device including this pickup.

### SUMMARY

According to an aspect of an embodiment, an apparatus comprises:

a plurality of object lenses mounted in a central portion;

a lens holder having tracking and focusing coils distributed between two side portions;

a fixed base having a plurality of magnets paired with the tracking and focusing coils and a plurality of stand-up mirrors each facing a different one of the object lenses;

a plurality of wires giving cantilever-like support to the two side portions of the lens holder; and

a coil substrate having a winding pattern as the tracking coil and integrated with the lens holder so as to cross through the central portion of the lens holder and project beyond the two side portions while avoiding the object lenses and the stand-up mirrors, wherein

a plurality of through holes are formed in the coil substrate for electrically connecting the plurality of wires as leads to the tracking and focusing coils.

### BRIEF DESCRIPTION OF THE DRAWINGS

FIG. 1 is an exploded perspective view showing a first embodiment of an optical pickup of the present invention;

FIG. 2 is an enlarged perspective view of a portion of the optical pickup shown in FIG. 1;

FIG. 3 is an exploded perspective view of the construction of the optical pickup shown in FIG. 1;

FIG. 4 is wiring diagram for the optical pickup shown in FIG. 1;

FIG. 5 is a wiring diagram of the optical pickup shown in FIG. 1;

FIG. 6 is an exploded perspective diagram showing another embodiment of an optical pickup of the present invention;

FIG. 7 is an enlarged wiring diagram of a portion of the optical pickup shown in FIG. 6;

FIG. 8 is a perspective diagram showing main parts of a further embodiment of an optical pickup of the present invention; and

FIG. 9 is a perspective diagram showing main parts of a further embodiment of an optical pickup of the present invention;

### DETAILED DESCRIPTION OF THE PREFERRED EMBODIMENTS

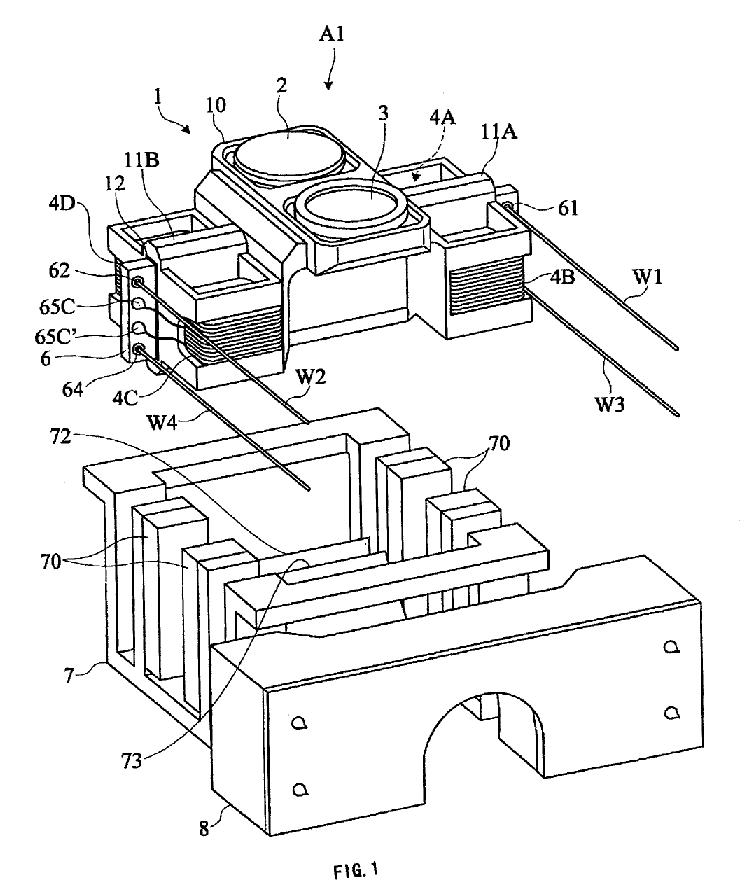

FIGS. 1 to 5 show a first embodiment of the optical pickup of the present invention. An optical pickup A1 has two types of lenses mounted therein corresponding to a plurality of optical disks (such as Blu-ray disks, DVDs and CDs) with different optical characteristics. The optical pickup A1 is provided in an optical disk device for recording to and reading out from the optical disks. The optical disk device further includes a driving means for rotatably driving the optical disks. The optical pickup A1 irradiates the optical disk being rotated by the driving unit with a recording or readout light beam and detects a reflected light beam due to light reflected from the optical disk irradiated by the light beam.

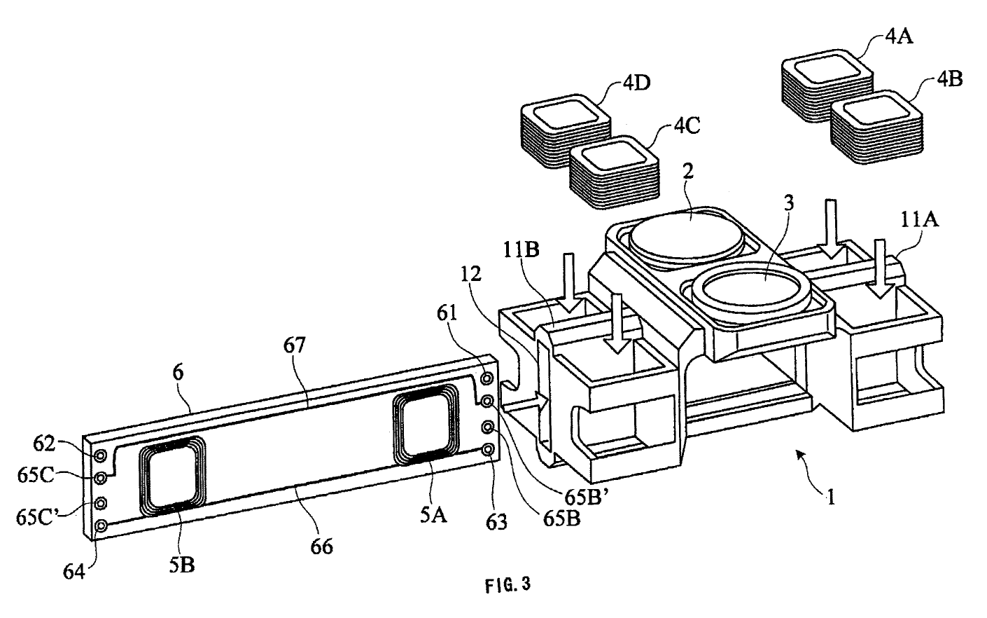

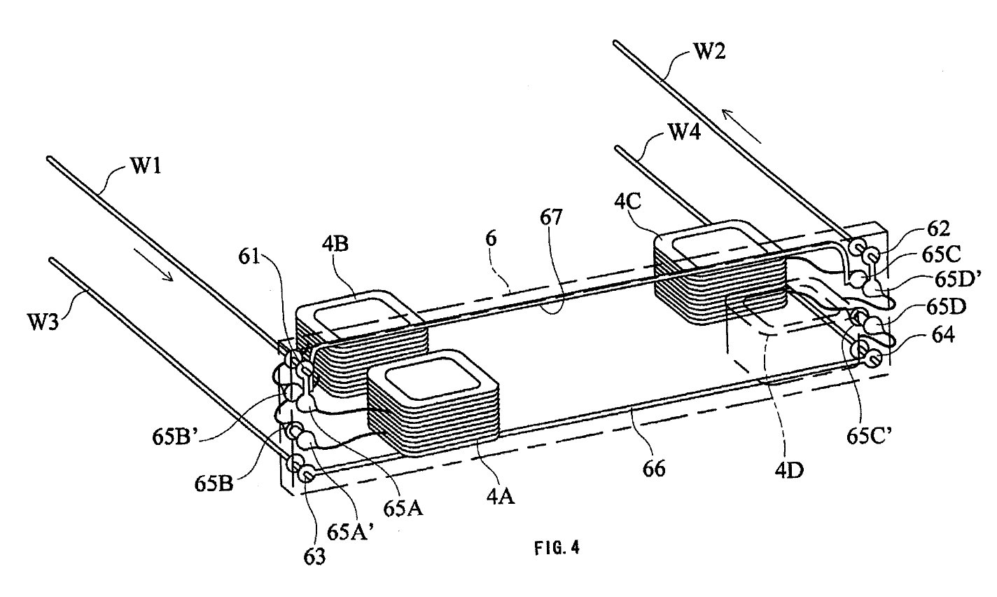

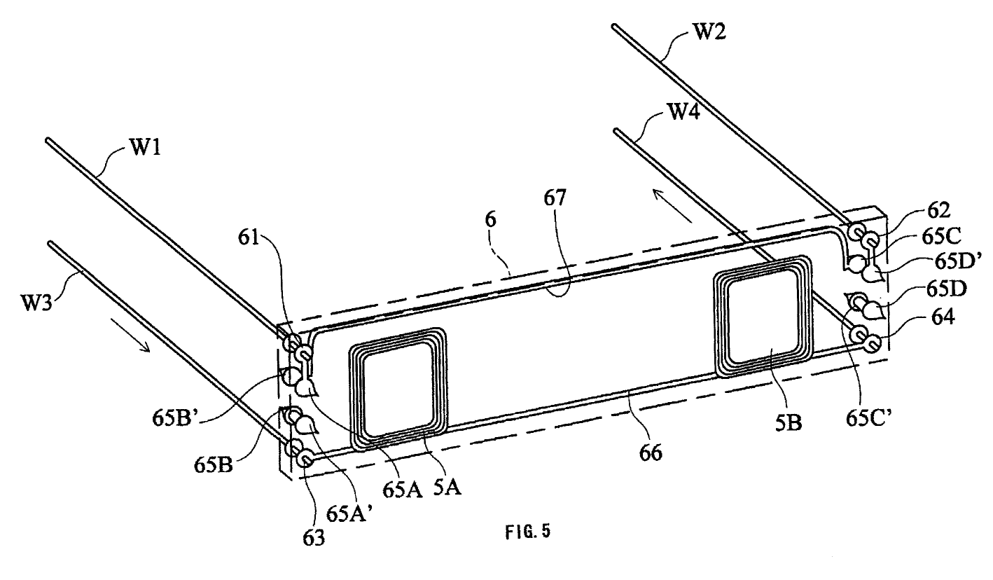

As shown in FIG. 1, the optical pickup A1 includes a lens holder 1, two object lenses 2 and 3, focusing coils 4A to 4D (see FIG. 3 and FIG. 4), a coil substrate 6 having winding patterns which are tracking coils 5A and 5B (see FIG. 3 and FIG. 5), a fixed base 7 provided with magnets 70 and stand-up mirrors 72 and 73. Wires W1 to W4 provide cantilever-like support for the lens holder 1 and function as leads to the coils, and a supporting member 8 is also provided.

The object lenses 2 and 3, the focusing coils 4A to 4D, and the coil substrate 6 are constructed so as to be integrated with the lens holder 1. In the drawings, the optical disk is disposed on an upper side of the optical pickup A1. A vertical direction is referred to as a focus direction, a direction intersecting with the wires W1 to W4 is referred to as a tracking direction or transverse direction, and a direction parallel to the wires W1 to W4 is referred to as a longitudinal direction.

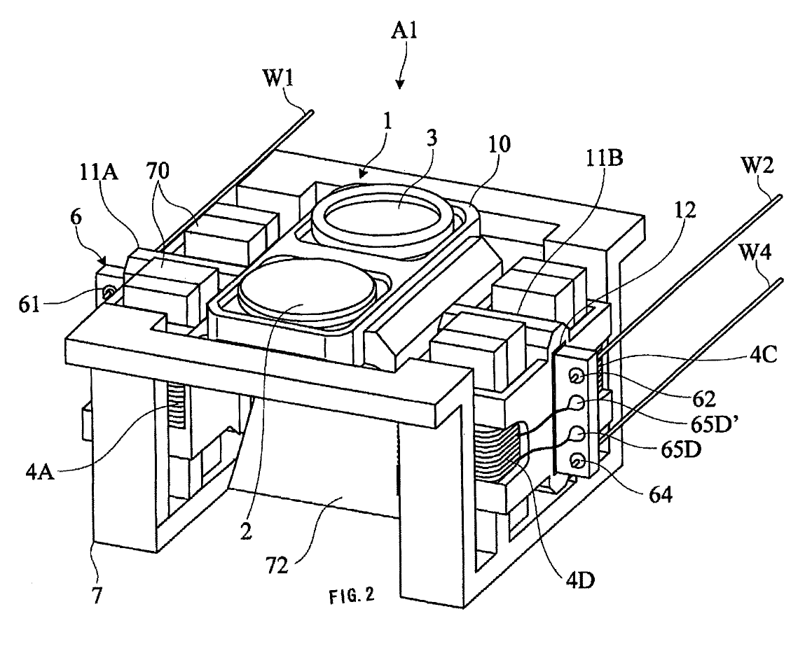

The lens holder 1 has a central portion 10 in which the object lenses 2 and 3 are mounted, two side portions 11A and 11B, located on each side of the central portion 10 and into which the focusing coils 4A to 4D are integrated, and an insertion hole 12 for insertably fixing the coil substrate 6. The central portion 10 is located upwards of the side portions 11A and 11B. Deployment spaces for the stand-up mirrors 72 and 73 and the coil substrate 6 are located downwards of the central portion 10. The two object lenses 2 and 3 are mounted in the central portion 10 so as to align in the longitudinal direction with optical axes lying in the vertical direction. The focusing coils 4A to 4D are fixed to the two side portions 11A and 11B in such a way that the coil axes lie in the same direction as the optical axes of the lenses 2 and 3. As shown in FIG. 2, the magnets 70 are fixed to the fixed base 7 in central portions of the focusing coils 4A to 4D. As shown in FIG. 3, the coil substrate 6 is inserted into the insertion hole 12 from outside the lens holder 1. The coil substrate 6 is fixed so as maintain a parallel attitude with respect the vertical and transverse directions and so as to cross through a lower side of the central portion 10 while avoiding the optical paths of the object lenses 2 and 3 and the stand-up mirrors 72 and 73. The two end portions of the coil substrate 6 are fixed to project from the insertion hole 12 of the two side portions 11A and 11B.

The object lens 2 is used, for instance, for recording to and reading out from a first optical disk. The object lens 2 transmits laser light guided upwards by the stand-up mirror 72, and concentrates the laser light on a first optical disk. The other object lens 3 is used to transmit laser light guided upwards by the stand-up mirror 73, and concentrate the laser light on a second optical disk. The object lens 3 is used to record to and readout from the second optical disk, whose optical characteristics differ from the optical characteristics of the first optical disk. Formats for the first and second optical disks include CD, DVD, HD-DVD and Blu-ray. For instance, it is possible to set the object lens 2 to support CD or DVDs and the other object lens 3 to support Blu-ray disks.

The focusing coils 4A to 4D are electrically connected to the coil substrate 6 and are subjected to a force in the vertical direction due to electromagnetic interaction with the magnets 70. Thus, the lens holder 1 is moved in the focusing direction by controlling a size and direction of electric currents flowing in the focusing coils 4A to 4D. Note that the coils 4A to 4D of the present embodiment are all controllable so the forces all act in the same direction.

As shown in FIG. 4 and FIG. 5, through holes 61 to 64 are formed in the two end portions of the coil substrate 6 for electrically connecting tip portions of the wires W1 to W4. Further, terminals 65A, 65A′, 65B, 65B′, 65C, 65C′, 65D and 65D′ are formed in the two end portions of the coil substrate 6 for electrically connecting the focusing coils 4A to 4D. The tracking coils 5A and 5B are formed at two locations, which face the magnets 70, in proximity to the two end portions of the coil substrate 6, and the axes of the coils 5A and 5B lie in the longitudinal direction. The through holes 61 and 62 of an upper side of the two end portions of the coil substrate 6 connect to upper side terminals 65A and 65D′ via respective wiring patterns. The other through holes 63 and 64 on the lower side of the two end portions connect to the tracking coils 5A and 5B via a wiring pattern 66. The terminals 65A, 65B′, 65C and 65D′ on both upper surfaces of the two end portions of the coil substrate 6 are connected to the terminals 65B′ and 65C on a single surface via a wiring pattern 67. The other terminals, meanwhile, are formed without direct connections to one another. Further, the terminals 65A′, 65B, 65C′ and 65D on the lower side of the two end portions of the coil substrate 6 are formed as through holes connecting with each other through the coil substrate 6. The focusing coils 4A through 4D are connected to the terminals 65A, 65A′, 65B, 65B′, 65C, 65C′, 65D and 65D′ by soldering each of lead lines, or the like.

In other words the focusing coils 4A to 4D are directly connected to the upper side wires W1 and W2. The tracking coils 5A and 5B are directly connected to the lower side wires W3 and W4. For instance, as shown in FIG. 4, the current entering via the wire W1 flows to the coil 4A via the through hole 61 and the terminal 65A, and then to the terminal 65A′ to the terminal 65B. Next, the current that has entered the terminal 65B flows into the coil 4B and then from the terminal 65B′ to the terminal 65C via the wiring pattern 67. The current that has entered the terminal 65C flows into the coil 4C and then into the coil 4D via the terminal 65C′ and the terminal 65D. The current that has flowed into the coil 4D exits from the wire W2 via the terminal 65D′ and the through hole 62. Further, as shown in FIG. 5 for instance, the current that has entered via the wire W3 flows to the coils 5A and 5B via the through hole 63 and the wiring pattern 66. Thereafter, the current exits from the wire W4 via the through hole 64. The tracking coils 5A and 5B are also subjected to transverse forces due to the electromagnetic interaction with the magnets 70. Thus, the lens holder 1 is moved in the tracking direction by controlling a size and direction of the electric currents flowing in the tracking coils 5A and 5B. Note that the base end portions of the wires W1 to W4 are fixed to the support member 8 as shown in FIG. 1, and are electrically connected to a driving circuit not shown in the drawings.

The lens holder 1 is constructed in the following manner.

First, as shown in FIG. 3, the focusing coils 4A to 4D are fitted into the two side portions 11A and 11B of the lens holder 1, and the coil substrate 6 is inserted into the insertion hole 12 and fixed therein.

Thereafter, as shown in FIG. 4, the lead lines of the focusing coils 4A to 4D are connected to the terminals 65A, 65A′, 65B, 65B′, 65C, 65C′, 65D, and 65D′ by soldering or the like.

Next, the tip portions of the wires W1 to W4 are inserted into the through holes 61 to 64 of the coil substrate 6 and they are connected by soldering or the like. Lastly, the base ends of the wires W1 to W4 are fixed to the supporting member 8. With this arrangement, the lens holder 1 is supported by the fixed base 7 so as to be movable in the focusing direction and the tracking direction via the wires W1 to W4, and it is possible to control driving of the focusing coils 4A to 4D and the tracking coils 5A to 5D.

Hence, according to the optical pickup A1 of the present embodiment, wiring of the tracking coils 5A and 5B is substantially completed by simply connecting the wires W1 to W4 to the through holes 61 to 64 of the coil substrate 6. Moreover, there is no need to interconnect the focusing coils 4A to 4D provided at the two end portions 11A and 11B of the lens holder 1. With this arrangement, the form of the connection is simpler than the form of the prior art in which wires connect to all of the coils, and the wiring can be implemented simply and quickly.

Further, the lens holder 1 has cantilever-like support from the wires W1 to W4 at both end portions of the coil substrate 6 in proximity to a center of gravity. With this arrangement, high precision focusing and tracking operations can be realized without resonance occurring during the operations.

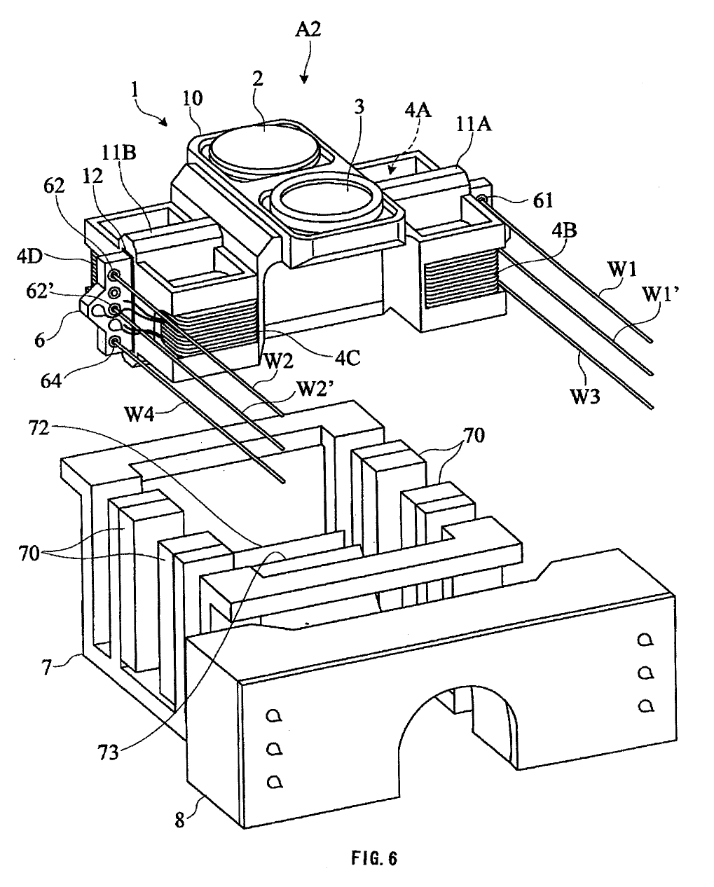

FIGS. 6 through 9 show another embodiment of the optical pickup of the present invention. Note that construction elements of the optical pickup of the second embodiment which are the same as those of the described embodiment have the same symbols, and further descriptions of these elements are omitted.

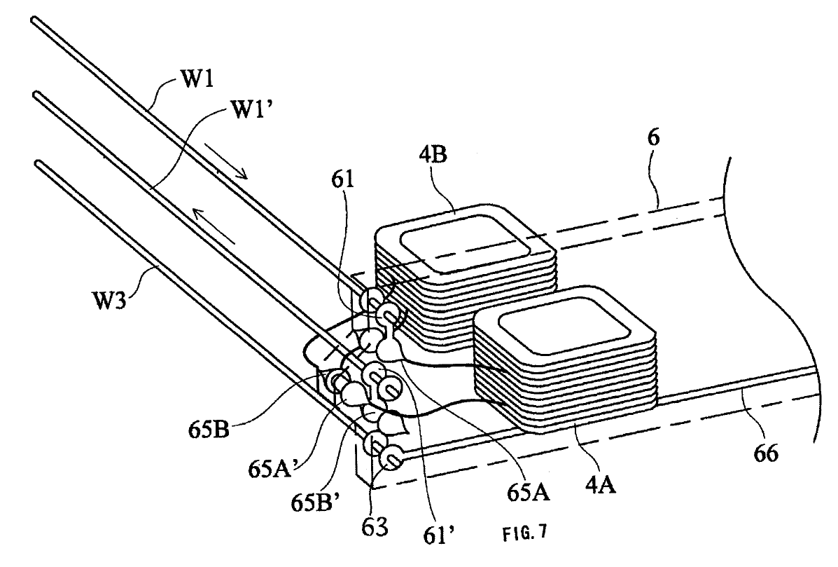

The optical pickup A2 shown in FIG. 6 and FIG. 7 differs from that of the described embodiment in that six wires, which are W1, W1′, W2, W2′, W3, and W4, are provided and differs in the form of the connection between the focusing coils 4A to 4D and the coil substrate 6. The coil substrate 6 has tracking coils, through holes, terminals and the like formed therein. However, since the two end portions where the through holes and terminals are provided have the same construction, the following describes the left-hand end portion, mainly referring to FIG. 7.

As shown in FIG. 7, through holes 61, 61′, and 63 are formed on the left-hand end of the coil substrate 6 for electrically connecting to tip portions of the wires W1, W1′ and W3 on one side. In addition, the terminals 65A, 65A′, 65B, and 65B′ are formed for electrically connecting the focusing coils 4A and 4B. The two through holes 61 and 61′ on an upper side of the end portion connect to the terminals 65A and 65B′ via respective wiring patterns. On the other hand, the through hole 63 on a lower side of the end portion connects to a tracking coil (not shown) via a wiring pattern 66. The two terminals 65A′ and 65B are formed as through holes so as to connect to each other through the coil substrate 6. The lead lines of the coil 4A are connected to the terminals 65A and 65A′ by soldering or the like. The lead lines of the other coil, which is coil 4B, are connected to the terminals 65B and 65B′ by soldering or the like. The connections on the opposite side have a similar form.

In other words, the focusing coils 4A and 4B located on one side are directly connected to the two wires W1 and W1′ on one side, and the coils 4C and 4D located on the other side are connected in a similar manner. Hence, it is possible to control the driving so that the electromagnetic actions of the coils on the left and right-hand sides are different. The tracking coil is directly connected to the wires W3 and W4 in a similar manner to the above described embodiment. For instance, as shown in FIG. 7, the current entering via the wire W1 flows into the coil 4A via the through hole 61 and the terminal 65A, and then the current flows from the terminal 65A′ to the terminal 65B. Next, the current that has entered the terminal 65B flows into the coil 4B, and then flows from the terminal 65B′, and exits from wire W1′ via the through hole 61′. Thus, lens holder 1 is caused to tilt by controlling the size and direction of the currents in the focusing coils 4A to 4D to generate forces of different direction and magnitude on the left and right sides. This allows tilt operations to be performed in addition to the focusing and tracking operations.

According to this construction, it is possible both to achieve the same effects as the above-described embodiment and to realize highly accurate tilt operations in addition to the focusing and tracking operations.

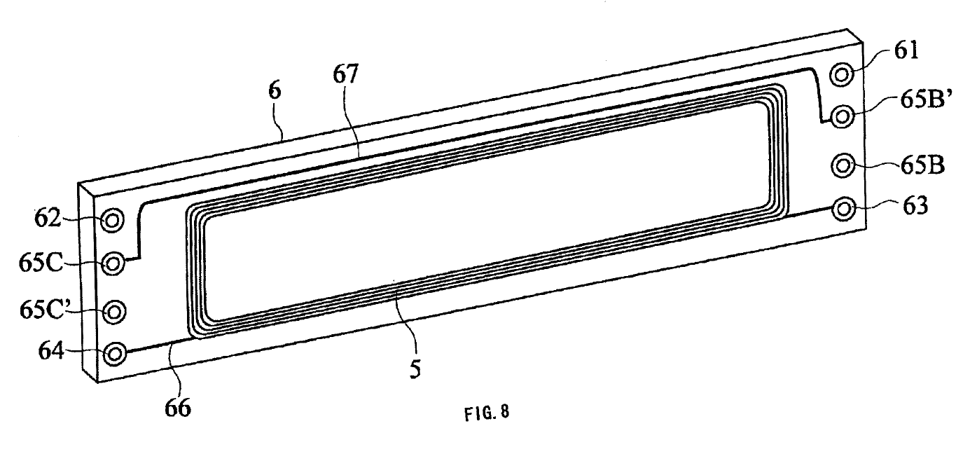

As shown in FIG. 8, as a further embodiment, the coil substrate 6 may have a single tracking coil 5 formed using a winding pattern. Provided a portion of the tracking coil 5 is located so as to face the magnets, this construction, like the above-described constructions, allows tracking operations to be performed by making use of electromagnetic effects.

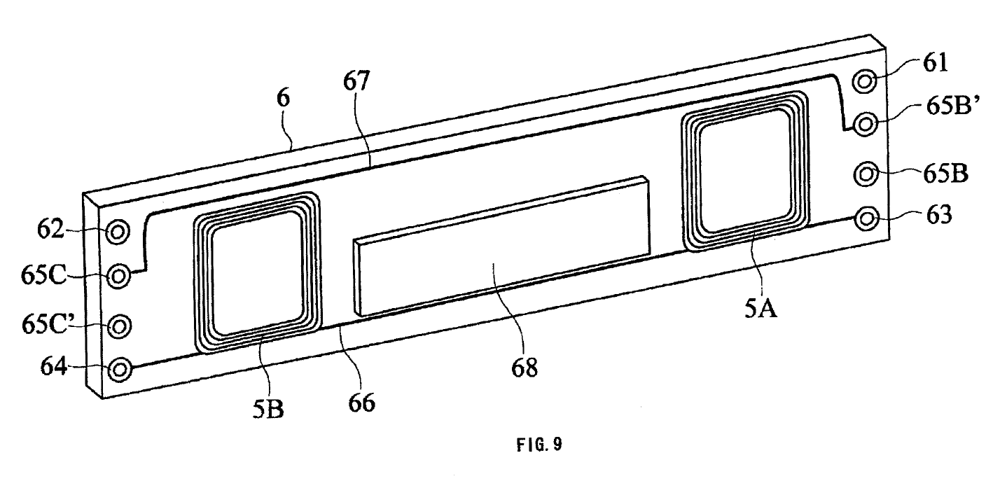

As shown in FIG. 9, as a further embodiment, a coil substrate 6 including a weight 68 for overall weight-balancing of the lens holder may be used. The weight 68 can be manufactured at low cost by using the same metallic material and manufacturing process as for the coils 5A and 5B. With such a construction, when the center of gravity of the lens holder is in the central portion and therefore high, it is possible to achieve vertical weight-balance by positioning the weight 68 there below. Such an arrangement makes it possible to effectively prevent inclination of the lens caused by subsynchronous resonance of the wires or the like.

Note that the present invention is not limited to the above described embodiments.

Provided at least one of a coil and a through hole is formed in the coil substrate, the number of wires and coils and the construction of the coil substrate can be modified appropriately according to specifications.

What is claimed is:

1. An optical pickup comprising:
a plurality of object lenses mounted in a central portion;
a lens holder having tracking and focusing coils distributed between two side portions;
a fixed base having a plurality of magnets paired with the tracking and focusing coils and a plurality of stand-up mirrors each facing a different one of the object lenses;
a plurality of wires supporting the two side portions of the lens holder; and
a coil substrate having a winding pattern as a tracking coil and integrated with the lens holder so as to cross through the central portion of the lens holder and project beyond the two side portions, wherein
a plurality of through holes are formed in the coil substrate for electrically connecting the plurality of wires as leads to the tracking and focusing coils.

2. The optical pickup according to claim 1, wherein
the coil substrate is integrated with the lens holder so as to lie parallel with optical axes of the object lenses and includes the wiring pattern as the tracking coil in at least two locations.

3. The optical pickup according to claim 2, wherein
focusing coils are provided, separated by the coil substrate, at four locations in the two side portions of the lens holder, and axes of the focusing coils align with the optical axes of the object lenses.

4. The optical pickup according to claim 3, wherein
a plurality of terminals for connecting the focusing coil are formed on the coil substrate, a number of the plurality of through holes are formed to connect to the wiring patterns that are tracking coils, and the remainder of the through holes are formed to connect to a number of the plurality of terminals.

5. The optical pickup according to claim 1, wherein
the coil substrate is provided with a weight for overall weight balancing of the lens holder.

6. An optical disk device comprising:
a driving means configured to hold and rotate an optical disk; and
an optical pickup configured to irradiate the optical disk being rotated by the driving unit with a recording or readout light beam and detect a reflected light beam produced by reflected light from the optical disk being irradiated by the irradiating light beam, wherein
the optical pickup includes: a lens holder provided with a plurality of object lenses mounted in a central portion, and tracking and focusing coils distributed between two side portions; a fixed base having a plurality of magnets paired with the tracking and focusing coils and a plurality of stand-up mirrors each facing a different one of the object lenses; a plurality of wires supporting the two side portions of the lens holder; and a coil substrate that has a winding pattern as the tracking coil, that is integrated with the lens holder so as to cross through the central portion of the lens holder and project beyond the two side portions, and has formed therein a plurality of through holes for electrically connecting the plurality of wires as leads to the tracking and focusing coils.

7. The optical disk device according to claim 6, wherein
the coil substrate is integrated with the lens holder so as to lie parallel with optical axes of the object lenses and includes the wiring pattern as the tracking coil in at least two locations.

8. The optical disk device according to claim 7, wherein
the focusing coil is provided at four locations on the lens holder side which are separated by the coil substrate, and axes of the focusing coils align with the optical axes of the object lenses.

9. The optical disk device according to claim 8, wherein
a plurality of terminals for connecting the focusing coil are formed on the coil substrate, a number of the plurality of through holes are formed to connect to the wiring patterns that are tracking coils, and the remainder of the through holes are formed to connect to a number of the plurality of terminals.

10. The optical disk device according to claim 1, wherein
the coil substrate is provided with a weight for overall weight balancing of the lens holder.
